(19) United States
(12) Patent Application Publication
(10) Pub. No.: US 2014/0280648 A1
(43) Pub. Date: Sep. 18, 2014

(54) Methods and Systems for Email Address Verification

(71) Applicant: Zulily, Inc., Seattle, WA (US)

(72) Inventors: Ryan D. Steingard, Seattle, WA (US); David L. Atchinson, Seattle, WA (US); Joshua D. Heidler, Frisco, TX (US)

(73) Assignee: Zulily, Inc., Seattle, WA (US)

(21) Appl. No.: 14/206,653

(22) Filed: Mar. 12, 2014

Related U.S. Application Data
(60) Provisional application No. 61/794,971, filed on Mar. 15, 2013.

(51) Int. Cl. H04L 29/08; H04L 12/58

(52) U.S. Cl. CPC H04L 67/141; H04L 51/30
USPC 709/206

(57) ABSTRACT

A method of verifying the validity of an email address includes establishing a communication session with a client device; receiving an email address from the client device during the communication session; and while the communication session with the client device remains active, performing an email verification procedure that includes (a) causing a first communication to be sent to the email address; (b) evaluating a second communication received in reply to the first communication; and (c) in response to receiving a second communication indicating that the email address is invalid, sending a request to the client device for a corrected email address. The method may include requesting further information from the client device after receiving the email address, and, while requesting further information from the client device, performing the email verification procedure. Steps (a) to (c) may be repeated using the corrected email address until a valid email address is received.

### CROSS-REFERENCE TO RELATED APPLICATION

This application claims the benefit of U.S. Provisional Patent Application No. 61/794,971, filed Mar. 15, 2013, the disclosure of which is incorporated by reference herein in its entirety.

### FIELD

This disclosure pertains to methods and systems for determining whether user-provided email addresses are valid.

### BACKGROUND

Email is a ubiquitous means for communication in the world today. Individuals and businesses alike rely on successful delivery of email to share information. In particular, businesses desire to obtain correct email addresses for customers so as to ensure an open channel for communication with their customers.

For example, businesses engaged in electronic commerce often desire to provide customers with periodic updates and promotional opportunities for purchasing their goods or services. In typical e-commerce situations, individuals who wish to obtain products or services from a business with a website are typically requested to provide their email address when they sign up for an account at the website. However, on occasion, a business later attempts to send an email to the provided email address and discovers that the address is invalid. Undeliverable emails represent lost opportunities for communication with customers. It is therefore desirable to identify improved processes for obtaining valid email information.

### SUMMARY

The following summary is provided to introduce a selection of concepts in a simplified form that are further described below in the Detailed Description. This summary is not intended to identify key features of the claimed subject matter, nor is it intended to be used as an aid in determining the scope of the claimed subject matter.

Described herein are various embodiments of a system and method that may be used for verification of user-provided email addresses. Preferably, the email verification procedures are performed contemporaneous with the user's provision of the email address. In such manner, the chances of obtaining valid email address information are vastly improved.

In at least one embodiment, a method of verifying the validity of an email address includes establishing, by a computing device, a communication session with a client device; receiving an email address from the client device during the communication session; and while the communication session with the client device remains active, performing an email verification procedure that includes: (a) causing a first communication to be sent to the email address; (b) evaluating a second communication received in reply to the first communication; and (c) in response to receiving a second communication indicating that the email address is invalid, sending a request to the client device for a corrected email address.

Also described herein is a computing system configured to facilitate verification of the validity of an email address. In at least one embodiment, the system includes computing equipment configured to operate in accordance with programmed software instructions, and a memory coupled to the computing equipment. The memory has computer-executable instructions stored therein that, in response to execution by the computing equipment, cause the computing equipment to establish a communication session with a client device; receive an email address from the client device during the communication session; and while the communication session with the client device remains active, perform an email verification procedure that includes (a) causing a first communication to be sent to the email address; (b) evaluating a second communication received in reply to the first communication; and (c) in response to receiving a second communication indicating that the email address is invalid, sending a request to the client device for a corrected email address.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a network-based communication system suitable for implementing email verification procedures according to the present disclosure; and

FIG. 2 illustrates a process with email verification procedures conducted in accordance with the present disclosure.

### DETAILED DESCRIPTION

FIG. 1 illustrates a network-based communication system 10 in which a plurality of client devices 12, 14, and 16 are communicatively coupled to a server 18 via a network 20. The client devices 12, 14, and 16 may be operated by individual users. In an electronic commerce environment, the users may be customers of a business that is operating the server 18. The network 20 might be a local or wide area network, or it may comprise part of the global Internet.

In response to requests for information from the client devices 12, 14, and 16, the server 18 may retrieve information from memory 22 and provide the information to the client devices. Likewise, the server 18 may request information from the client devices 12, 14, and 16. The server 18 may also send information to the client devices 12, 14, and 16 without request by the individual users. For example, the server 18 may periodically send informative or promotional emails to the users operating the client devices 12, 14, and 16. To do so, the server 18 must have valid email addresses for the users.

In a web environment, a user typically initiates a web browser operating on the user's client system and instructs the browser to communicate with the server 18 by providing the server's web address to the browser. The web browser initiates a communication session that is used to manage the flow of communication with the server 18. While the communication session is active, the server 18 recognizes incoming communications from the web browser and maintains the communication channels for outgoing communications to the web browser. Typically, the user's web browser also maintains information regarding the communication session. Even if a user closes his/her browser and later comes back and initiates a new communication with the server 18, by accessing stored information concerning the prior communication session, the server 18 is often able to reestablish communication with the user as if the prior communication session had not terminated.

In e-commerce situations, a business typically maintains account information for individual customers. A new account is typically generated for a user when the user first interacts with the business's website. When a user first seeks to establish an account, the business's server 18 typically collects information from the user. Such information is typically maintained in a user profile, which, in the context of FIG. 1, may be stored in the memory 22. As part of setting up an account, the server 18 may request the user to provide a valid email address. As will be discussed in more detail below, the server 18 attempts to validate the user's email while the communication session with the user remains active. If the server 18 is able to communicate with a user about an invalid email address before the user terminates the communication session, the server 18 is more likely to obtain a correct email address without having to watch and wait for the user to return before asking for a valid email address.

In FIG. 2, a process 30 for obtaining email address information, with email verification procedures, is illustrated. The process 30 begins at block 32 where the user has initiated a communication session with the server 18.

At a point in communication with the user, the server 18 requests the user to supply an email address, as indicated at block 34. Typically, users who wish to establish communication with the business respond by supplying an email address, as indicated at block 36. For various reasons, whether inadvertent or intended, a user may supply an email address that is invalid. In other words, the supplied email address is not recognized as corresponding with an active email account. Emails directed to invalid addresses are marked undeliverable and returned to the original sender.

To determine whether a supplied email address is valid, an email address verification procedure is conducted in accordance with the present disclosure, as shown at block 38. In some embodiments, the email verification procedure 38 entails multiple steps, depending on the particular implementation. For example, as a first step, a user-supplied email address may be scrutinized for known misspellings. For example, if a user enters the email address “name@ gmai.com,” the address verification procedure 38 may recognize the address “gmai.com” as a common misspelling of the Gmail system provided by Google, Inc. In one implementation, the address verification procedure 38 may maintain a table of common misspellings and compare received email addresses against the table. If a user-supplied email address matches a common misspelling, the server 18 may determine at block 40 that the address is invalid and return to block 34 to request the user to again supply a valid email address.

Even if an email address is not found to contain common misspellings, the server 18 still does not know whether the email address is truly valid. Accordingly, as another step in the address verification procedure 38, and in accordance with the present disclosure, the server 18 may prepare and send an introductory email to the supplied email address, while the communication session with the user is still active. For example, if the user is engaged in a signup procedure to set up a new account, the signup procedure may be structured to ask for the user's email address early in the procedure, and then proceed to obtain additional information for establishing the user's account. During this time of obtaining additional information for the user's account, the server 18 may send an email to the user thanking the user for coming to the website. If the user-supplied email address is invalid, the server 18 is notified fairly quickly that the sent email was undeliverable. For whatever reason the email was undeliverable, the server 18 may determine at block 40 that the email address is invalid and return to block 34 to request a valid email address.

Recognizing that a user may have inadvertently provided an invalid email address, the communication with the user at block 34 may be different after an invalid email address has been found than the communication made to the user at the initial instance when the user was first requested to supply an email address. Such communication at this stage may, for example, indicate the recognition of a common misspelling and ask the user to check the supplied email address for possible correction. In other circumstances, communications may employ a positive tone and indicate that the user will miss out on benefits if a valid email address is not received.

During the address verification procedure 38, return communications from the user's email server are typically classified as indicating deliverable or undeliverable (invalid) email. If no communication is received from the user's email server, it is assumed that the outgoing introductory email to the user was successfully delivered.

On occasion, a user may implement an auto-reply feature of their email account, such as an out-of-office assistant, that provides automated feedback to senders of the email. Such “out-of-office” emails are generally considered as indicating successful delivery of a sent email. Thus, no further action by the server 18 is needed.

However, if the server 18 receives an automated communication indicating that the address in a sent email is bad or that the email account is unknown, the server 18 determines that the sent email was undeliverable and therefore concludes the address is invalid. In accordance with the present disclosure, the address verification procedure 38 is conducted early enough within an expected communication period to allow for sending of an email and receiving an indication of undeliverability, if any. It is expected that if an invalid email address is identified early enough, while a communication session with the user is still active, the server 18 has much greater opportunity to obtain a corrected, valid email address. By obtaining valid email addresses from a greater percentage of customers while the customers are still engaged in communication with the server 18, the server 18 is able to more effectively communicate with the customers. In a business context, having effective communication with customers is essential for improved opportunities to conduct further business with the customers. When the email verification procedure 38 results in a determination that a user-supplied email address is valid (for example, an email immediately sent to the user does not provoke an indication of undeliverable), the user-supplied email address is stored in memory for future use, as indicated at block 42. In circumstances where the user was in process of signing up for an account, the validated email address is stored in association with the user's account.

Returning to FIG. 1, there may be circumstances in which the server 18 is not configured to send email communications to customers, but rather the server 18 relies on other computing equipment, possibly operated by a third party, to send emails on the server's behalf. For example, the server 18 may rely on computing equipment 24 to send emails to customers. The server 18 may communicate with the computing equipment 24 using a network communication link 26. Alternatively, the server 18 may communicate with the computing equipment 24 using a direct communication link 28.

Upon receipt of an email address from a user, the server 18 may immediately communicate the email address to the computing equipment 24 while the communication session between the server 18 and the user remains active. The computing equipment 24 is configured to immediately send an email communication to the supplied address. If the computing equipment 24 receives an automated reply indicating that the email was not delivered, the computing equipment informs the server 18 that the email address is invalid. The server 18 may then engage the user, as discussed above, and request that the user check the supplied address and make corrections to ensure that a valid email address is provided. In circumstances where the computing equipment is not configured to immediately inform the server 18 of undeliverable email, the server 18 may instead employ a polling procedure to check an email delivery log maintained by the computing equipment 24. The server 18 should poll the delivery log shortly after the email address was supplied so as to determine as soon as possible whether an email sent to the address was not successfully delivered. In this manner, the server 18 is able to communicate with the user regarding the user's email address while the communication session with the user is still active.

While various embodiments of the present disclosure have been illustrated and described above, it will be further appreciated that various changes can be made therein without departing from the spirit and scope of the invention.

The embodiments of the invention in which an exclusive property or privilege is claimed are defined as follows:

1. A method of verifying the validity of an email address, the method comprising:
establishing, by a computing device, a communication session with a client device;
receiving an email address from the client device during the communication session; and
while the communication session with the client device remains active, performing an email verification procedure that includes:
(a) causing a first communication to be sent to the email address;
(b) evaluating a second communication received in reply to the first communication; and
(c) in response to receiving a second communication indicating that the email address is invalid, sending a request to the client device for a corrected email address.

2. The method of claim 1, further comprising, while the communication session with client device remains active, evaluating the email address for known misspellings, and in response to recognizing a misspelling in the email address, sending a request to the client device for a corrected email address.

3. The method of claim 1, wherein after establishing the communication session with the client device, the method further includes:
sending a request to the client device for an email address;
after receiving the email address from the client device, requesting further information from the client device; and
while requesting further information from the client device, performing the email verification procedure.

4. The method of claim 1, further comprising repeating steps (a) to (c) using the corrected email address until a valid email address is received.

5. The method of claim 1, wherein when the second communication indicates that the first communication was undeliverable, the email address is considered invalid.

6. The method of claim 1, wherein when the second communication received in reply to the first communication is an auto-reply communication from an email account identified by the email address, the email address is considered valid.

7. The method of claim 1, wherein the computing device sends the first communication to the email address.

8. The method of claim 1, wherein the computing device causes other computing equipment to send the first communication to the email address.

9. The method of claim 8, wherein the second communication is received by the other computing equipment.

10. The method of claim 9, further comprising polling, by the computing device, a delivery log maintained by the other computing equipment for receipt of a second communication in reply to the first communication.

11. A computing system configured to facilitate verification of the validity of an email address, the system comprising:
computing equipment configured to operate in accordance with programmed instructions; and
a memory coupled to the computing equipment, wherein the memory has computer-executable instructions stored therein that, in response to execution by the computing equipment, cause the computing equipment to:
establish a communication session with a client device;
receive an email address from the client device during the communication session; and
while the communication session with the client device remains active, perform an email verification procedure that includes:
(a) causing a first communication to be sent to the email address;
(b) evaluating a second communication received in reply to the first communication; and
(c) in response to receiving a second communication indicating that the email address is invalid, sending a request to the client device for a corrected email address.

12. The system of claim 11, wherein while the communication session with the client device remains active, the instructions further cause the computing equipment to evaluate the email address for known misspellings and in response to recognizing a misspelling in the email address, cause a request to be sent to the client device for a corrected email address.

13. The system of claim 11, wherein the instructions further cause the computing equipment to:
send a request to the client device for an email address;
after receiving the email address from the client device, request further information from the client device; and
while requesting further information from the client device, perform the email verification procedure.

14. The system of claim 11, wherein the instructions further cause the computing equipment to repeat steps (a) to (c) using the corrected email address until a valid email address is received.

15. The system of claim 11, wherein when the second communication indicates that the first communication was undeliverable, the email address is considered invalid.

16. The system of claim 11, wherein when the second communication is an auto-reply communication from an email account identified by the email address, the email address is considered valid.

17. The system of claim 11, wherein the instructions cause the computing device to send the first communication to the email address.

18. The system of claim 11, wherein the instructions cause the computing device to direct other computing equipment to send the first communication to the email address.

19. The system of claim 18, wherein the other computing equipment is configured to receive the second communication.

20. The system of claim 19, wherein the instructions further cause the computing equipment to poll a delivery log maintained by the other computing equipment for receipt of a second communication in reply to the first communication.
